(19) United States
(12) Patent Application Publication
(10) Pub. No.: US 2005/0031938 A1
(43) Pub. Date: Feb. 10, 2005

(54) Rapidly rechargeable electric power system

(76) Inventors: Robert Van Burdine, Ardmore, TN (US); Howard Allen Foote, La Quinta, CA (US)

Correspondence Address: Robert Van Burdine, 600 Rolin Hollow Rd, Ardmore, TN, 38449, US

(21) Appl. No.: 10/764,715

(22) Filed: Jan. 26, 2004

Related U.S. Application Data
(60) Provisional application No. 60/442,787, filed on Jan. 27, 2003.

(51) Int. Cl. H01M 8/04; H01M 2/38

(52) U.S. Cl. 429/68; 429/23; 429/81

(57) ABSTRACT

Method and device for the continuous refueling of a battery suitable for mobile and stationary power applications are provided. A methodology is described comprised of the formation of a continuous electrochemical transport and current conduction belt battery cell, being subdivided into a plurality of electrochemical cells comprising a high current source at a desirable voltage. Means are described for a refuelable battery-forming device. The device is suitable to receive electrochemical fuel in a variety of forms from powders to pellets to continuous ribbons and produce electrical current at a high rate.

This application claims the priority of a provisional patent application 60/442,787, filed Jan. 27, 2003, the entire disclosure of which is specifically incorporated herein by reference.

References

U.S. Patent Documents

U.S. Patent Documents

| | | | |
|---|---|---|---|
| 228888 | June 1880 | Griscom | 429/110. |
| 395028 | December 1888 | Bailey et al. | 429/127. |
| 3023259 | February 1962 | Coler et al. | 429/127. |
| 3293080 | December 1966 | Gruber et al. | 429/68. |
| 3310437 | March 1967 | Davee et al. | 429/242. |
| 3357864 | December 1967 | Huber | 429/113. |
| 3379574 | April 1968 | Grulke et al. | 429/116. |
| 3432354 | March 1969 | Jost | 136/86. |
| 3494796 | February 1970 | Grulke et al. | 136/83. |
| 3536535 | October 1970 | Lippincott | 136/86. |
| 3551208 | December 1970 | Stachurski | 429/68. |
| 3577281 | April 1969 | Pountney et al. | 136/6. |
| 3592698 | July 1971 | Hideo Baba | 429/68. |
| 3663721 | May 1972 | Blondel et al. | 429/131. |
| 3725131 | April 1973 | Pountney et al. | 136/86. |
| 3743543 | July 1973 | Chiku et al. | 429/193. |
| 3827912 | August 1974 | Justice | 429/14. |
| 4001037 | January 1977 | Beck | 429/188. |
| 4076909 | February 1978 | Lindstrom | 429/207. |
| 4145482 | March 1979 | Von Benda | 429/27. |
| 4349615 | September 1982 | Reitz | 429/110. |
| 4916036 | April 1990 | Cheiky | 429/127. |
| 5250370 | October 1993 | Faris | 429/68. |
| 5536592 | July 1996 | Celeste et al. | 429/68. |
| 6186732 | February 2001 | Brown et al | 414/528 |
| 6299997 | October 2001 | Faris et al. | 429/27 |
| 6335111 | January 2002 | Faris et al. | 429/13 |
| 6365292 | April 2002 | Faris et al. | 429/27 |
| 6403244 | June 2002 | Faris et al. | 429/27 |
| 6410174 | June 2002 | Faris et al. | 429/13 |
| 6558830 | May 2003 | Faris et al. | 429/27 |
| 6569555 | May 2003 | Faris et al. | 429/27 |
| 6649294 | November 2003 | Faris et al. | 429/27 |

A mechanically refuelable battery of long duration and having high capacity is provided by the present invention. The battery is configured such that the electrochemistry is automatically configured into the proper geometry for optimum battery performance without the need of external electrochemical transport and current conduction belts or electrochemical packaging of any kind. Electrochemical fuel can be fed into the battery in a number of forms including but not limited to pellets, paste, flakes, powder, granules, slugs, ribbon, chunks or any other form that is convenient and will allow a high surface exposure of the electrochemical components. The battery is readily and conveniently refueled in this manner. This battery can be used to power an electric vehicle competitive in performance with an internal combustion engine yet be free of pollution. Such a power system may also be used for stationary power, and for long-term storage at remote locations where instant power may be required.

### FIELD OF THE INVENTION

This invention relates to a method and device for the conversion of electrochemical components into electrical energy in a continuous manner, said components being supplied to device in a variety of mechanical forms. The method and device are suitable for both stationary and mobile applications.

### BACKGROUND OF THE INVENTION

Providing continuous electrical power at high current drain rates from a battery source over long periods of time is problematic due to the consumption and surface degradation (passivation) of the limited amount of electrochemical material that can be contained inside the battery casing. Attempts to produce battery driven vehicles has been hampered by the relatively low energy densities achievable in conventional batteries. The necessity to convert many applications currently served by fossil fuel burning engines to totally electric power for the purposes of reducing environmental pollution is increasingly being pointed out in the media and political, and well as scientific, circles.

The practical realization of such a device has been approached in numerous ways, the most common being that of an externally refuelable battery where electrochemical reactants are replaced in order to “recharge” the battery instead of electrically reversing the batteries reactions through an external electrical source. The proposed methods have included such schemes as having a electrochemical transport and current conduction belt wound onto a spool or in a spiral configuration the continuously supplies the battery reactants until the electrochemical transport and current conduction belt electrochemistry is exhausted. The electrochemical transport and current conduction belt is then removed and replaced with a new one to continue the process. Other proposals include the replacement of pouches of electrochemical reactants, or the introduction of magnetically charged reactants that self organizes themselves into the proper form of a battery. All of these methods require some modification of the battery itself in order to accomplish the refueling function. The present invention requires no modification of electrochemical transport and current conduction belts or pouches or the processing or handling of any material other than the electrochemical reactants themselves.

In the case of the automotive industry, the application of battery powered cars has been slow due to a number of factors. The considerations for the battery have driven the cost of such a vehicle far beyond the cost competitive region as compared with conventional fossil fueled vehicles. The currently available batteries can power such a vehicle for about one hundred miles before it is necessary to connect to the power grid or another source of electrical power to recharge the battery. The extensive recharge time makes such a vehicle highly impractical for any excursion beyond its single charge capacity of about one hundred miles roundtrip.

The possibility of building a hybrid electric battery vehicle where the fossil fueled engine is operated in an optimum manner and drives a generator device that continuously recharges the battery is also a topic of discussion. While this type of vehicle has been known for several years, it has not been commercially implemented due to the added cost and complexity, and the failure to have true independence from fossil fuels.

The technological possibility to have a truly fossil fuel independent energy source for transportation that has characteristics similar to the fossil fueled engine in terms of easy refueling and enough duration to operate distances of several hundred miles between refueling is very desirable and is realized in the present invention. Also, the possibility to store an electrical source at a remote and/or environmentally hostile location for extended periods of time and reliably generate electrical power on demand is also realized in the present invention.

It is also desirable to provide a method and device that produces said electrical power independent of fossil fuels.

It is also desirable to provide a method and device in the form of a continuously operating battery that is readily and practically refuelable, and has performance characteristics similar to the fossil fuel engine.

It is therefore desirable to develop and provide a method and device for high electrical output on demand from a battery device that is continuously refuelable and will operate for extended periods of time, incorporating many of the operational aspects of the internal combustion engine without the use of fossil fuels and their related pollution.

### SUMMARY OF THE INVENTION

The ability of the present invention to use electrochemical reactants in a variety of physical forms allows the widest choice of fuel options possible. For example, if the common lead-acid reaction were selected as the electrochemistry for the battery, the sulfuric acid electrolyte would be installed in the battery and a function provided for the continual recharge of the consumed acid. The spongy lead and the lead oxide would be introduced to the battery and automatically integrated into the battery electrochemical transport and current conduction belt electrode forming viable and near standard plates in the battery. The solid materials could be introduced as ribbon, pellets, granules, flakes or powders, or combinations as desired to more readily facilitate the refueling function.

The electrochemical reactant plates of the present invention are formed by layering the solid active electrochemical battery components into a carrier electrochemical transport and current conduction belt that maintains the required geometry of the reactants and carries them into the electrolyte. Components of the electrochemical transport and current conduction belt act as the conductor to remove electrical current as it is produced.

The spent electrochemical reactant material is removed from the electrochemical transport and current conduction belt by mechanically separating the electrochemical transport and current conduction belt layers and driving the electrolyte solution through the electrochemical transport and current conduction belt components, first from one side and then the other, to “blow” or force out any remaining reactant or spent reactant material. The electrochemical transport and current conduction belt is then reloaded with the electrochemical components and mechanically layered into the proper geometry and the process begins again.

The energy density and capacity of the cell is determined by the width of the electrochemical transport and current conduction belt and the corresponding width of the electrochemical load that can be realized, and the number of electrochemical transport and current conduction belt turns around the electrical pickoff rollers, and the length of the electrochemical transport and current conduction belt between the electrical pickoff rollers. It may be seen therefore, that the energy density of the cell is determined by the amount of electrochemical material that can be practically added and the energy density of the electrochemistry itself.

The battery is comprised of a fluid-containing cell. This cell can be drained and refilled.

Electrolyte density is monitored and it is supplemented from a concentrated store of the principal component of the electrolyte.

A float determines the electrolyte density. As the electrolyte content is depleted, the electrolyte density goes down and the float begins to sink. The float is designed to sink and activate a signal at a determined minimal allowable density for the electrolyte. The signal causes highly concentrated electrolyte to be added to the battery restoring the proper concentration of electrolyte.

The electrochemical transport and current conduction belt velocity is determined by monitoring the battery voltage and current, and adjusting the electrochemical transport and current conduction belt velocity accordingly, thereby augmenting the amount of electrochemical reactant solid material remaining in the electrolyte and adding new material in predetermined increments as necessary. In this manner the solid electrolytic reactants are always adequate to maintain battery power.

The electrolyte is continuously pumped through the cell to aid in the removal of product buildup on the solid reactants of the cell. Materials removed from the solid reactants drop into the bottom of the battery enclosure and are removed during the refueling process.

The invention embodies a device and method for providing a continuous source of electrical current from a battery that is continuously refuelable, and bears many of the operational characteristics and advantages of the internal combustion engine without the use of fossil fuels and their inherent pollution. While the preferred embodiments of the invention are shown and described herein, it is to be distinctly understood that the invention is not limited thereto, but may be otherwise variously embodied and practiced.

These and many other features and advantages of the invention will become apparent as the invention becomes better understood by reference to the following detailed description when considered in conjunction with the accompanying drawings.

### BRIEF DESCRIPTION OF THE DRAWINGS

FIG. 1 is a geometric representation of the internal battery electrochemical transport and current conduction electrochemical transport and current conduction belt.

FIG. 2 is a geometric representation of the internal battery electrochemical transport and current conduction electrochemical transport and current conduction belt showing granular electrochemical material.

FIG. 3 shows the transportation and conduction electrochemical transport and current conduction belt with electrochemical material loaded in the central area of the electrochemical transport and current conduction belt.

FIG. 4 represents the formation of the internal transport and conduction electrochemical transport and current conduction belt with continuous feed ribbon electrochemical materials being inserted into the proper layers.

FIG. 5 represents the formation of the internal transport and conduction electrochemical transport and current conduction belt with granular electrochemical materials being inserted into the proper layers.

FIG. 6 details the internal transport and conduction electrochemical transport and current conduction belt continuous feed electrochemical fuel loading.

FIG. 7 details the internal transport and conduction electrochemical transport and current conduction belt granular feed electrochemical fuel loading.

FIG. 8 represents the internal transport and conduction electrochemical transport and current conduction belt path through the battery.

FIG. 9 represents the casing and support infrastructure for the battery.

FIG. 10 represents the removal of spent electrochemicals from the transport and conduction electrochemical transport and current conduction belt.

FIG. 11 shows the geometry for the removal of electrical energy from the battery.

FIG. 12 shows the preferred method of driving the internal transport and conduction electrochemical transport and current conduction belt.

FIG. 13 represents details of the preferred method of driving the internal transport and conduction electrochemical transport and current conduction belt.

FIG. 14 represents the major elements of the internal transport and conduction electrochemical transport and current conduction belt drive system.

FIG. 15 details elements of the internal transport and conduction electrochemical transport and current conduction belt system.

FIG. 16 represents the drive component of the internal transport and conduction electrochemical transport and current conduction belt system.

FIG. 17 represents a more compact version of the drive component of the internal transport and conduction electrochemical transport and current conduction belt system.

FIG. 18 represents the non-driven return rollers for the internal transport and conduction electrochemical transport and current conduction belt system.

### DETAILED DESCRIPTION OF THE INVENTION

The above and other objects and advantages of the invention will be apparent upon consideration of the following detailed description, taken in conjunction with the accompanying drawings, in which like reference numbers refer to like parts throughout, and in which:

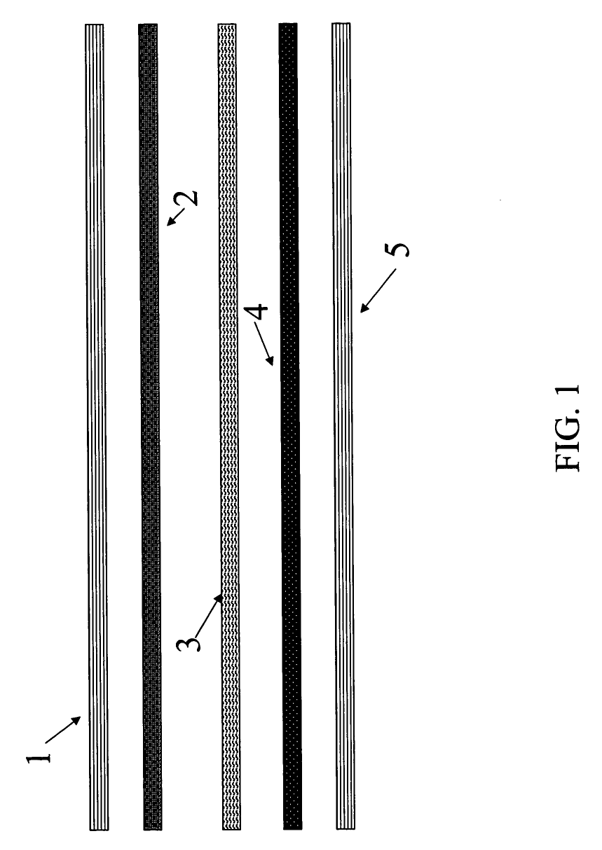

FIG. 1 is a geometric representation of the internal battery electrochemical transport and current conduction electrochemical transport and current conduction belt. Electrically conductive transport and current conduction belt 1 provides both mechanical strength and electrical conductivity. It is made preferably of a woven metal, such as stainless steel, forming a barrier to the unreacted electrochemical load and allowing reacted particulate to pass through. The electrochemical reactant 2 represents a continuous feed of cathode or anode fuel material in the form of a ribbon, fibrous tow, or belt, or other such continuous feed. The electrochemical reactant 4 represents a continuous feed of the complementary fuel material to fuel material 2, fuel material 4 being either the cathode or the anode, in the form of a ribbon, fibrous tow, or belt, or other such continuous feed. The electrolytic divider 3 separates and electrically isolates the anode and the cathode from one another. Divider 3 allows the ready transport of ions via the electrolytic bath between the electrochemical anode and cathode materials, facilitating the electrochemical reaction to produce electrical current that is transported away by electrically conductive transport and current conduction belts 1 and 5. Divider 3 is preferably made of fiberglass belt, but may be constructed of any material that is electrically isolating but allows the flow and transport of solution transported ions. Electrically belt 5 provides both mechanical strength and electrical conductivity. It is made preferably of a woven metal, such as stainless steel, forming a barrier to the unreacted electrochemical load and allowing reacted particulate to pass through.

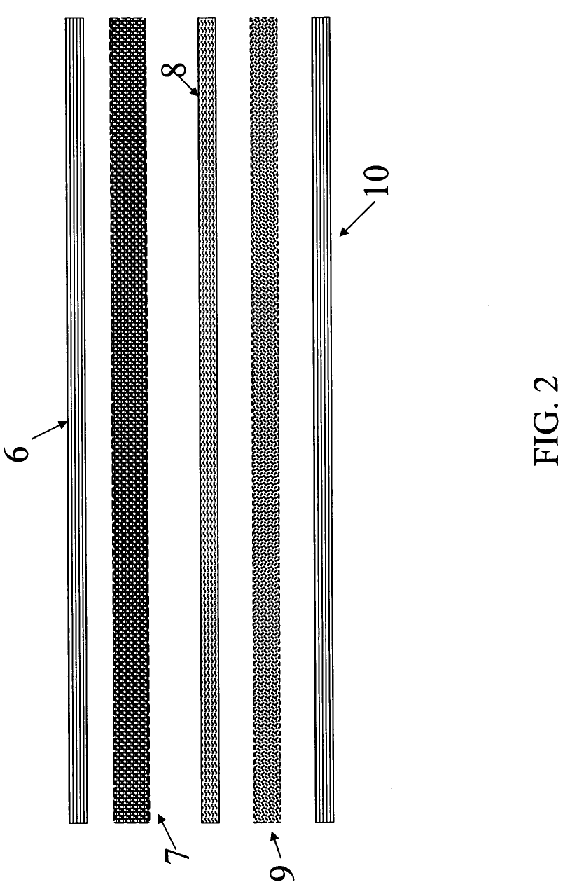

FIG. 2 is a geometric representation of the internal battery electrochemical transport and current conduction belt 11 showing granular electrochemical material. Electrically conductive belt 6 provides both mechanical strength and electrical conductivity. It is made preferably of a woven metal, such as stainless steel, forming a barrier to the unreacted electrochemical load and allowing reacted particulate to pass through. The electrochemical reactant 7 represents a granulated feed of cathode or anode fuel material in the form of a powder, slug, pellet, flake, paste or similar non-continuous feed. The electrochemical reactant 9 represents a non-continuous feed of the complementary fuel material to fuel material 7, fuel material 9 being either the cathode or the anode, in the form of a powder, slug, pellet, flake, paste or similar non-continuous feed. The electrolytic divider 8 separates and electrically isolates the anode and the cathode from one another, and does not allow passage of fuel materials 7 or 9 through divider 8. Divider 8 allows the ready transport of ions via the electrolytic bath between the electrochemical anode and cathode materials, facilitating the electrochemical reaction to produce electrical current that is transported away by electrically conductive electrochemical transport and current conduction belts 6 and 10. Divider 8 is preferably made of fiberglass belt, but may be constructed of any material that is electrically isolating but allows the flow and transport of solution born ions. Electrically conductive belt 10 provides both mechanical strength and electrical conductivity. It is made preferably of a woven metal, such as stainless steel, forming a barrier to the unreacted electrochemical load and allowing reacted particulate to pass through. Conduction belts 6 and 10 are more tightly woven than current conduction belts 1 or 5 so that the granulated fuel material may not pass through.

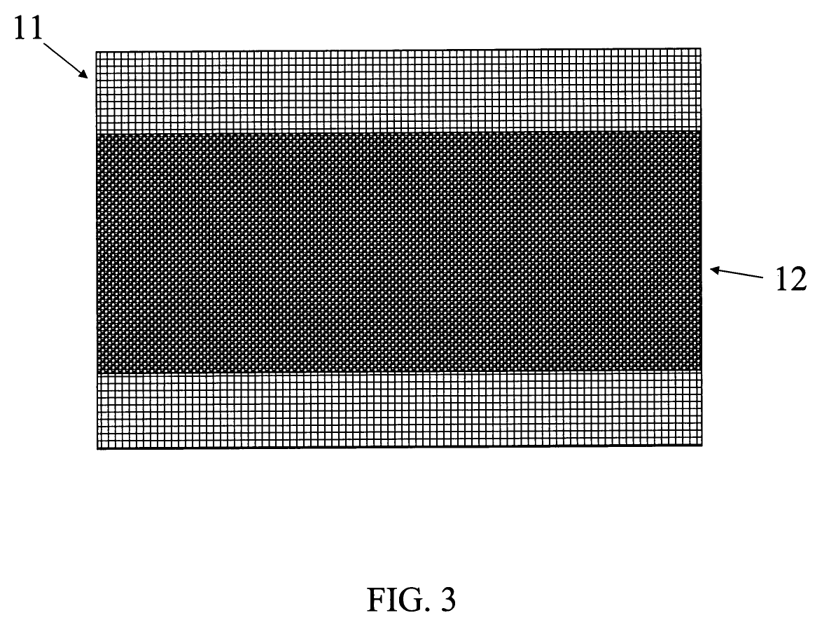

FIG. 3 shows the electrochemical transport and current conduction belt 11 with either granular or continuous-feed electrochemical material 12 loaded in the central area of the electrochemical transport and current conduction belt 11. It is a preferred embodiment that electrochemical transport and current conduction belt 11 is wider than the band of load fuel material 12 to reduce and eliminate spillage. Electrochemical transport and current conduction belt 11 is sufficiently wide giving fuel material 12 the ability to spread within electrochemical transport and current conduction belt 11 without the possibility of spillage. It is a preferred embodiment of the present invention that a electrochemical transport and current conduction belt 11 as per FIG. 3 is formed and reformed presenting a continuous and unbroken method and apparatus of forming, reacting, and cleaning, and then reforming electrochemical components representing and acting as the plates in a battery.

It is a further preferred embodiment of the present invention that the electrochemical transport and current conduction belts 1 and 5, and 6 and 10, are electrically conductive, and that they are constructed from woven metal. It is a preferred embodiment that said electrochemical transport and current conduction belts be made of a continuous band of metal, and it is a preferred embodiment that said electrochemical transport and current conduction belts be constructed of conductive plastic, either interwoven or continuous band.

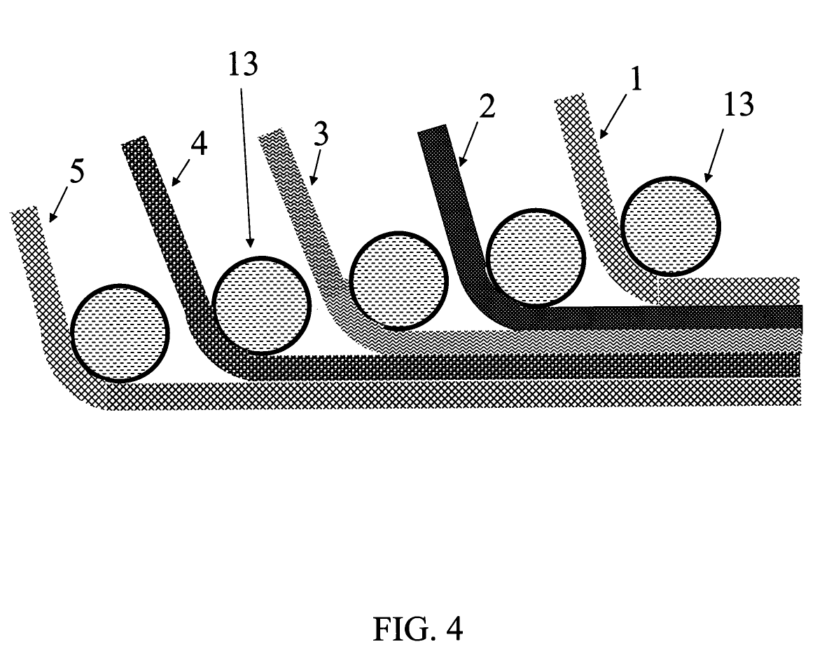

FIG. 4 represents the formation of the electrochemical transport and current conduction belt 11 with continuous-feed electrochemical materials being inserted into the proper layers. Electrochemical fuel components 2 and 4 are sandwiched between the current conduction belts 1 and 5, and the electrolytic divider 3. It is a preferred embodiment of the present invention that feed rollers 13 may be positioned either in a rising manner as shown or in a horizontal arrangement as necessary to facilitate holding the formed electrochemical transport and current conduction belt 11 in a stable and slightly compressed condition to maintain the containment of the fuel loads 2 and 4. In this manner electrochemical transport and current conduction belt 11 is continuously recharged with fuel loads 2 and 4, and formed into the proper geometry to facilitate battery activity.

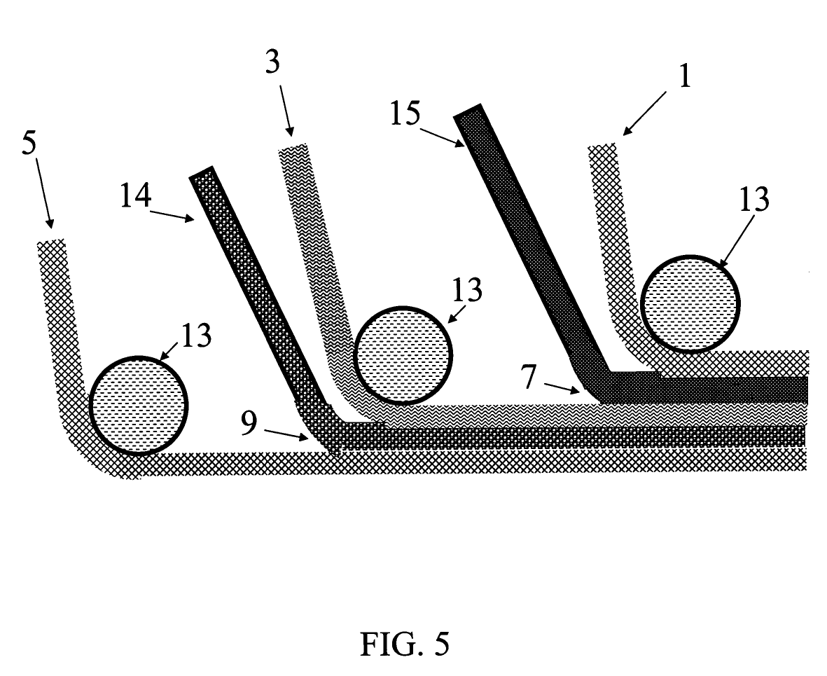

FIG. 5 represents the formation of the electrochemical transport and current conduction belt 11 with non-continuous feed electrochemical materials being inserted into the proper layers. Electrochemical fuel components 7 and 9 are fed from insertion mechanisms 14 and 15, and are sandwiched between the transport and current conduction belts 1 and 5, and the electrolytic divider 3. It is a preferred embodiment of the present invention that feed rollers 13 may be positioned either in a rising manner as shown or in a horizontal arrangement as necessary to facilitate holding the formed electrochemical transport and current conduction belt 11 in a stable and slightly compressed condition to maintain the containment of the fuel loads 7 and 9. In this manner electrochemical transport and current conduction belt 11 is continuously recharged with fuel loads 7 and 9, and formed into the proper geometry to facilitate battery activity. It is a preferred embodiment of the present invention that the formation of a continuous electrochemical transport and current conduction belt is facilitated requiring only the addition of the raw electrochemistry without external carrier or take-up mechanism.

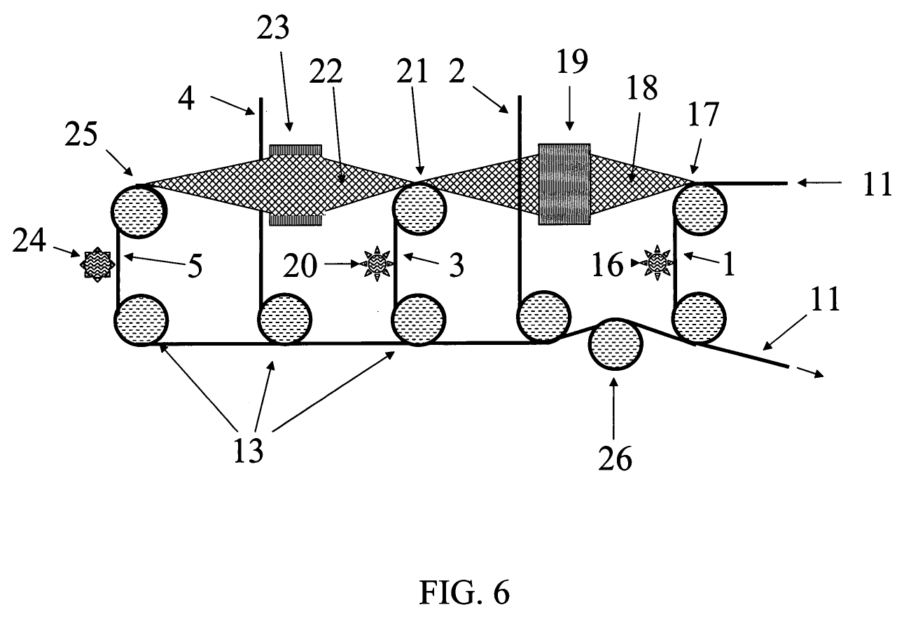

In order to feed the electrochemicals onto the electrochemical transport and current conduction belt 11 in the proper order, it is necessary to arrange the elements of the electrochemical transport and current conduction belt 11 to allow the insertion of the electrochemical materials into the electrochemical transport and current conduction belt 11 forming system. In FIG. 6 the details of the internal electrochemical transport and current conduction belt 11 continuous feed electrochemical fuel, 2 and 4, loading are detailed. The electrochemical transport and current conduction belt 11 is separated at point 17, with the transport and conduction belt 1 being pulled away by a feed roller 13, and being swept by brush 16 to remove any remaining particulate, including spent or unspent electrochemical fuel, and is recombined with the recharged electrochemical transport and current conduction belt 11 components to form a new and fully recharged electrochemical transport and current conduction belt 11. The electrolytic divider 3 and the transport and conduction belt 5 are together at point 18 and are turned ninety degrees by feed roller 19, facilitating the electrochemical fuel 2 integration into electrochemical transport and current conduction belt 11. At point 21 the electrochemical transport and current conduction belt 11 is further separated by the electrolytic divider 3 being pulled away by a feed roller 13, brushed by brush 20 to remove any materials that might be stuck to the electrolytic divider 3, and the electrolytic divider 3 is reintegrated into electrochemical transport and current conduction belt 11. At point 22 the remaining transport and conduction belt 5 is turned ninety degrees in a manner opposite that at point 18, by feed roller 23. This facilitates the electrochemical fuel 4 integration into electrochemical transport and current conduction belt 11. The transport and conduction belt 5 is turned by a feed roller 13, and is then swept by brush 24 to remove any particulate, and is again turned by a feed roller 13 for integration into electrochemical transport and current conduction belt 11. The tension feed roller 26 tightens the electrochemical transport and current conduction belt 11 just prior to the final integration with transport and conduction belt 1 to fully form electrochemical transport and current conduction belt 11. It is a preferred embodiment of the present invention that electrochemical transport and current conduction belt 11 enters this recharging device without a reactive electrochemical load and exits this device fully charged and geometrically arranged to produce electrical current.

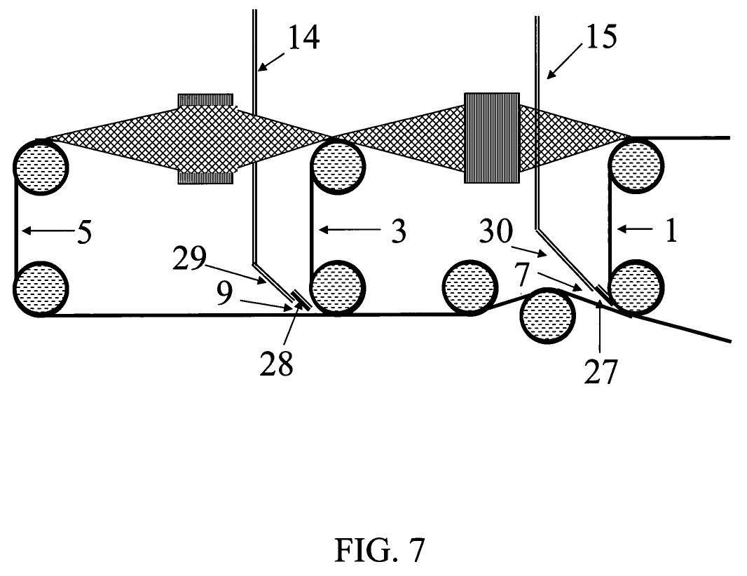

FIG. 7 represents the formation of the electrochemical transport and current conduction belt 11 with non-continuous feed electrochemical materials, 7 and 9, being inserted into the proper layers. Electrochemical fuel components 7 and 9 are fed from insertion mechanisms 14 and 15, and are sandwiched between the transportation and conduction electrochemical transport and current conduction belts 1 and 5, and the electrolytic divider 3. The insertion mechanisms 14 and 15 are configured at points 29 and 30 to layer the electrochemical fuel components, 9 and 7, into electrochemical transport and current conduction belt 11. Wipers 28 and 27 are positioned to smooth any clumped or otherwise non-homogeneous layering of the electrochemical fuel.

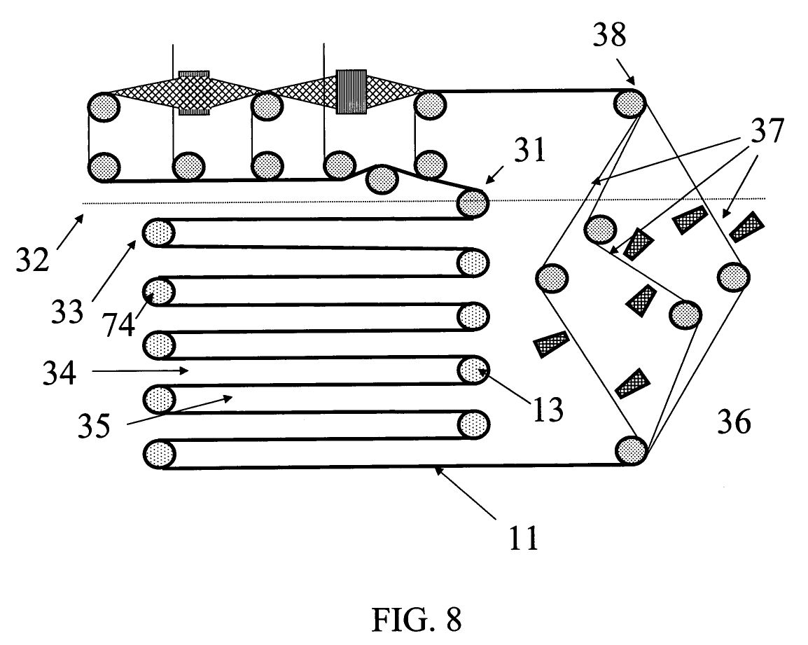

The path of electrochemical transport and current conduction belt 11 through the battery is shown in FIG. 8. At point 31, the electrochemical transport and current conduction belt 11, along with its now complete charge of electrochemical reactants, is submerged into the fluid electrolyte, the level of which is indicated by 32. The electrochemical transport and current conduction belt 11 is formed by feed rollers 13 and drive rollers 74 into alternating battery plates, producing a potential voltage and electrical current. At turning points, such as 33, the electrochemical transport and current conduction belt 11 is forced to move in a half circle around either drive rollers 74 or feed rollers 13, and, due to the electrochemical transport and current conduction belt 11 being made of multiple belts at slightly different distances from the center of the roller, slippage occurs between the belts forcing the electrochemical load to be sheared along the axis of the movement of the electrochemical transport and current conduction belt 11. This forces continuous exposure of non-reacted electrochemistry and allows reacted particulate to be forced out of the electrochemical transport and current conduction belt 11.

The spaces 34 and 35 shown in FIG. 8 are spaces of opposite polarity. For example, at space 34 the same electrochemical transport and current conduction belt 11 component is always facing itself thereby producing a zone of like charge. At space 35, the electrochemical transport and current conduction belt 11 has reversed itself one hundred and eighty degrees geometrically, and the opposite electrochemical transport and current conduction belt 11 component is always facing itself thereby producing a zone of like charge that is opposite to the charge in space 34.

The electrochemical transport and current conduction belt 11 in FIG. 8, after cycling through numerous drive rollers 74 and feed rollers 13, is at the bottom of the battery and has exhausted its electrochemical load. The electrochemical transport and current conduction belt 11 now enters the cleaner separator 36 where the component belts of electrochemical transport and current conduction belt 11 are separated allowing spent and any remaining unspent electrochemistry to drop out of the electrochemical transport and current conduction belt 11 and fall to the bottom of the battery casing. Electrochemical transport and current conduction belt 11 component belt path lengths 37 are all equal so as not to produce strain on the electrochemical transport and current conduction belt 11 components. Electrochemical transport and current conduction belt 11 is recombined at 38 and is free of the majority of its electrochemical load.

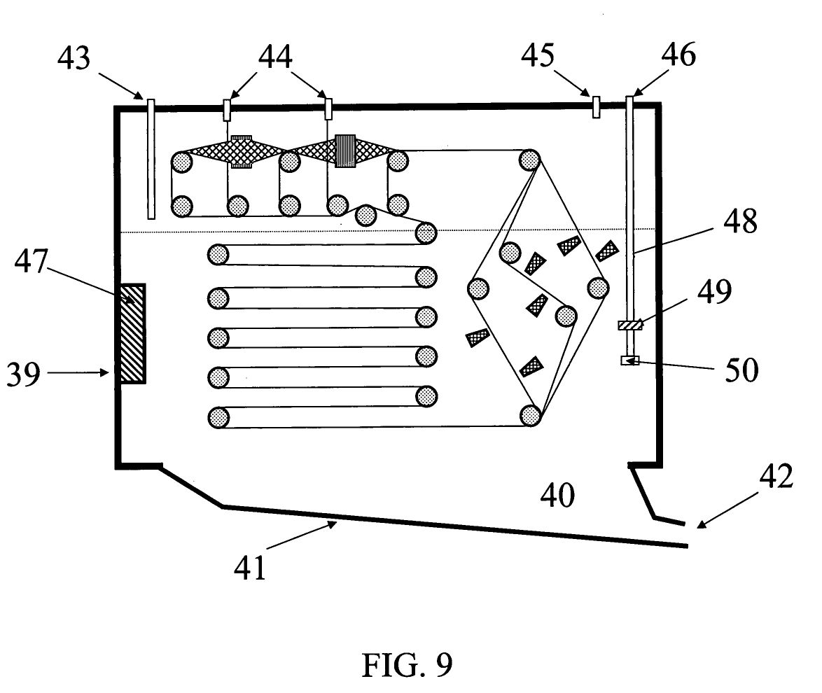

FIG. 9 represents the casing 39 and support infrastructure for the battery. The space 40 allows spent electrochemistry to accumulate until it is removed in the refueling process through drain port 42. Slope 41 assists in the removal of spent electrochemistry through drain port 42. Electrolyte is inserted and replenished into the battery through port 43. This concentrated electrolyte replenishment is determined by the action of the electrolyte density measurement mechanism 46. The electrolyte density measurement mechanism 46 operates by a float 49 of selected density and displacement that moves along the probe rod 48. As the float 49 encounters a higher density of electrolyte, float 49 is floated up along probe rod 48. As float 49 encounters a lower density of depleted electrolyte, float 49 sinks along probe rod 48. Probe rod 48 detects the position of float 49 and, when float 49 is sinking, electrolyte density measurement mechanism 46 signals for more electrolyte concentrate to be added to the battery through port 43. Electrolyte circulation pump 47 circulates and mixes the electrolytic mix in the battery to maintain homogeneity. As the float 49 rises, the electrolyte density measurement mechanism 46 signals for electrolyte concentrate to stop being added to the battery through port 43. The float stop 50 prevents float 49 from disengaging from probe rod 48 by falling off the end of probe rod 48. New electrochemical fuel is added through ports 44. Port 45 maintains the rate of pressure change in battery casing 39, allowing the internal pressure to equalize with the external air pressure until no net force is exerted on battery casing 39 from gaseous pressure differences.

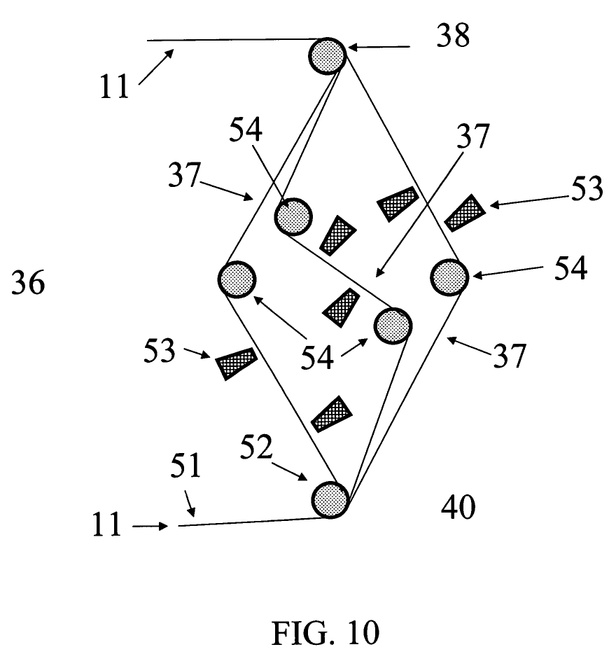

FIG. 10 represents the removal of spent electrochemicals from the electrochemical transport and current conduction belt 11 component belts. The electrochemical transport and current conduction belt 11 enters the separator cleaner 36 at point 51 with depleted and fully reacted electrochemistry incapable of adding any additional current production to the battery. It is now necessary to remove all remaining material from the electrochemical transport and current conduction belt 11 prior to refueling. The electrochemical transport and current conduction belt 11 is separated at point 52 into its component electrochemical transport and current conduction belts. The electrolyte is ejected through electrolyte nozzles 53 against the separated component belts of electrochemical transport and current conduction belt 11, first from one side of the component belt and then the other to loosen and dislodge any remaining material in the component belts of electrochemical transport and current conduction belt 11. Electrolyte circulation pump 47 provides the pressurized electrolyte for the operation of electrolyte nozzles 53. The tensioning feed rollers 54 apply equal tension to the component belts to remove any differences in tension between the component belts assuring a tight and functional electrochemical transport and current conduction belt 11. The component belt path travel distances 37 through cleaner separator 36 are all equal. The electrochemical transport and current conduction belt 11 is recombined from the component electrochemical transport and current conduction belts at point 38. The electrochemical transport and current conduction belt 11 is now free of any electrochemistry and is in a condition to be recharged.

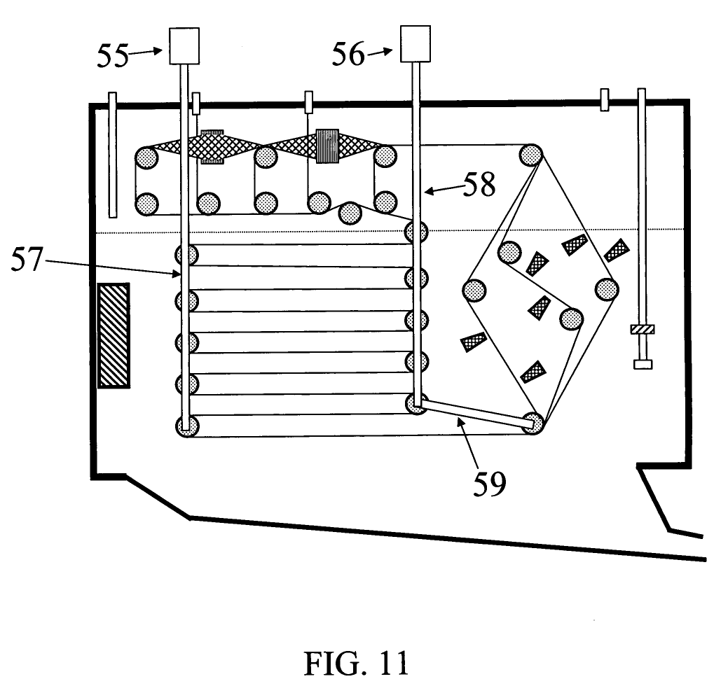

FIG. 11 shows the geometry for the removal of electrical energy from the battery. Battery terminals 55 and 56 are each connected to the respective roller sets through roller support and conduction mechanisms 57 and 58. Support and conduction mechanism 58 is extended through addition 59 to complete the last possible plate of the battery, assuring the maximum opportunity to react all the available electrochemistry before the removal of material from electrochemical transport and current conduction belt 11. Battery terminals 55 and 56 are at opposite polarities and may be attached to for current drain in a manner consistent with any high current battery.

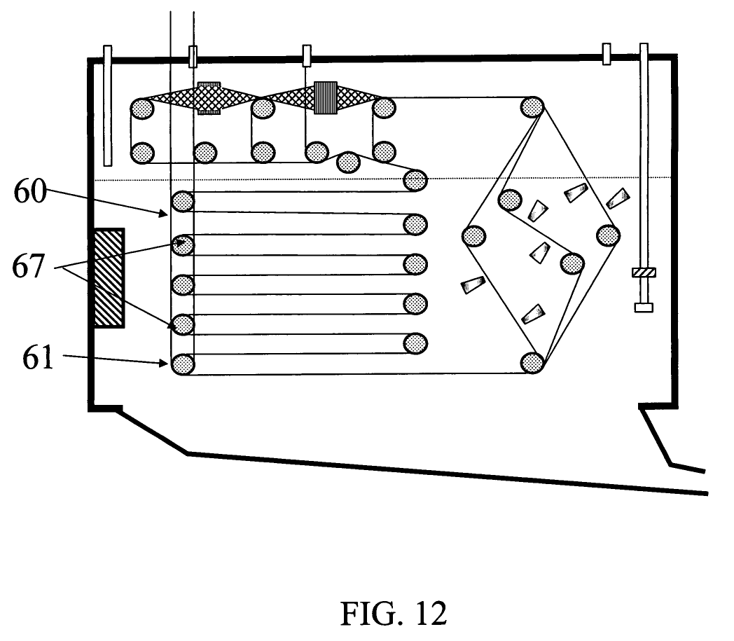

FIG. 12 shows the preferred method of driving the electrochemical transport and current conduction belt 11. A drive electrochemical transport and current conduction belt 60 is provided and engages drive rollers 67, wrapping around the bottom most drive roller at point 61, and returning to make a complete and continuous loop again engaging drive rollers 67.

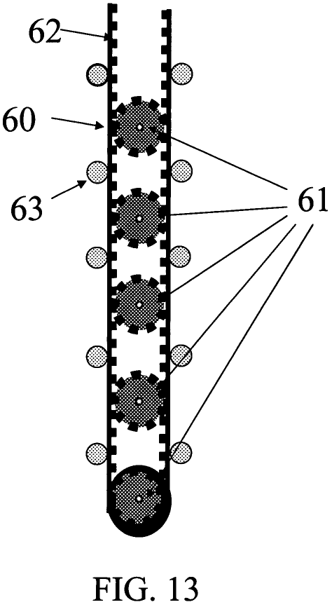

FIG. 13 represents details of the preferred method of driving electrochemical transport and current conduction belt 11. Drive belt 60 engages drive rollers 61 through cogged belt detail 62. Tension rollers 63 maintain contact of drive electrochemical transport and current conduction belt 60 with drive rollers 61.

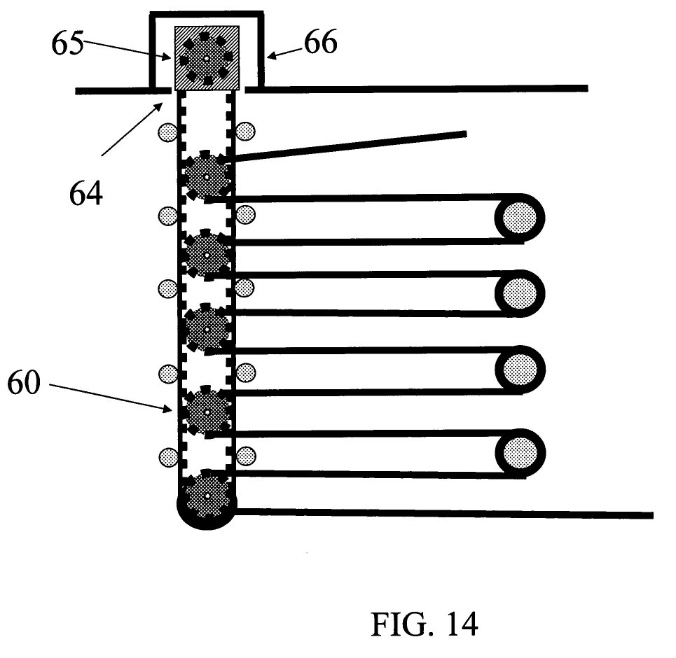

FIG. 14 represents the major elements of the electrochemical transport and current conduction belt 11 drive system. Motor 65 turns drive belt 60. Motor 65 is housed as a sealed component of battery through removable housing 66. Housing lip 64 protects motor 65 from excessive exposure to internal battery electrolyte.

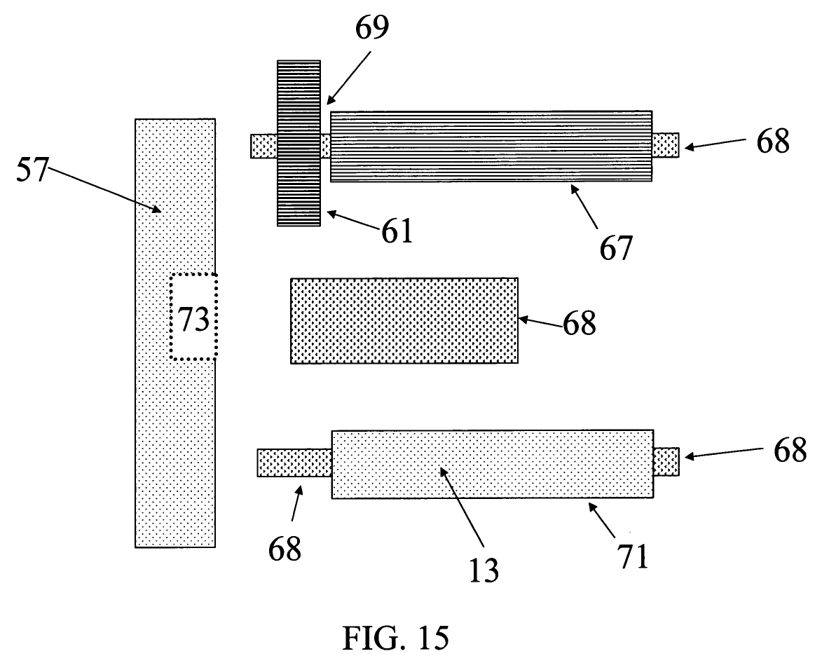

FIG. 15 details elements of the electrochemical transport and current conduction belt 11 drive system. The drive roller surface 67 is textured for suitable engagement of electrochemical transport and current conduction belt 11. Drive roller 61 engages drive belt 60 and transfers torque through shaft to drive roller surface 67. Space 69 separates and allows adjustment for respective belt engagements. The feed roller 13 is attached to shaft 68, and exhibits a smooth surface 71. Shafts 68 engage slot 73 as an attachment to conduction mechanisms 57 and 58 respectively.

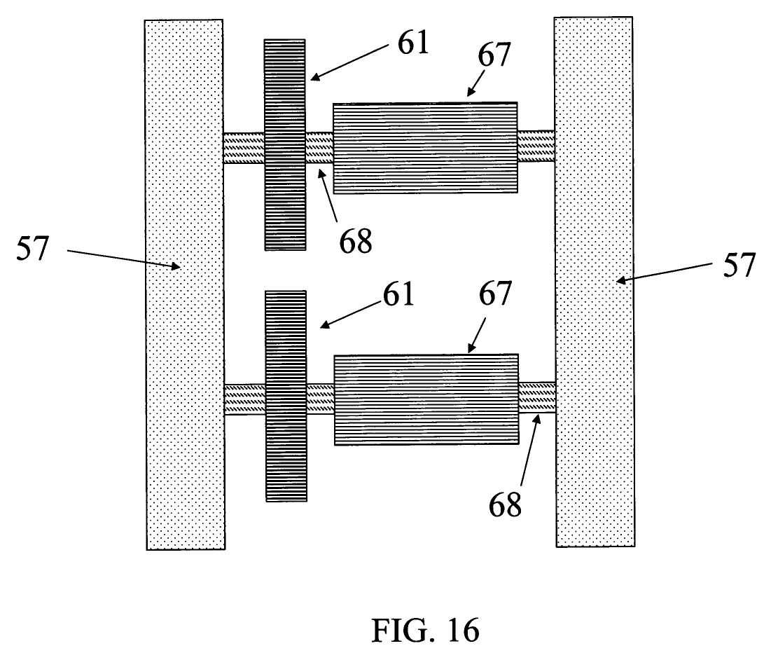

FIG. 16 represents the drive component electrochemical transport and current conduction belt 11 drive system in their respective geometry.

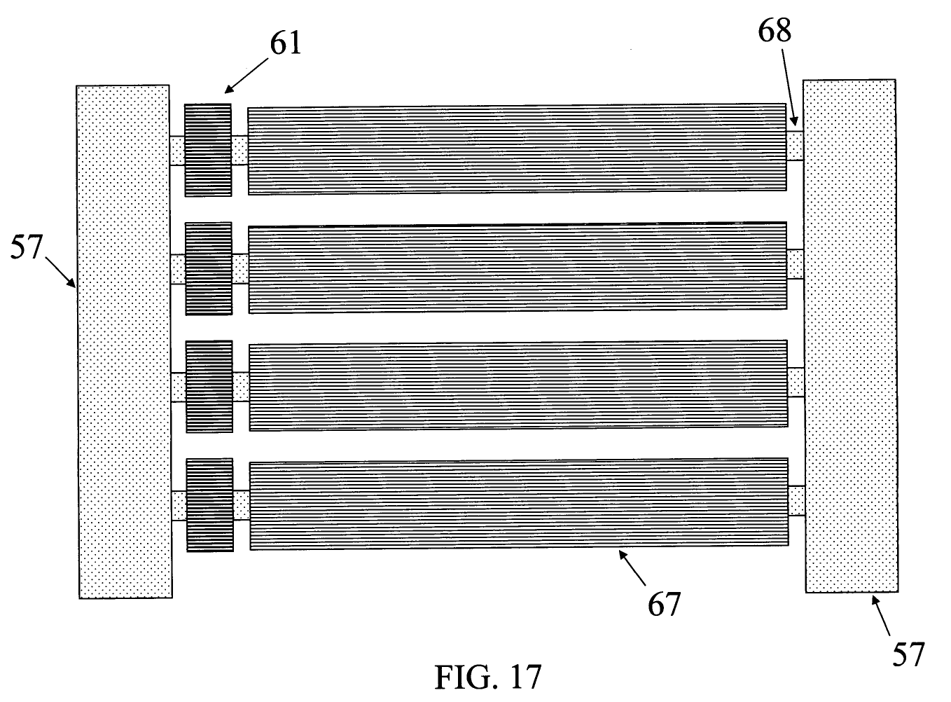

FIG. 17 represents a more compact version of the drive component of the electrochemical transport and current conduction belt 11 drive system.

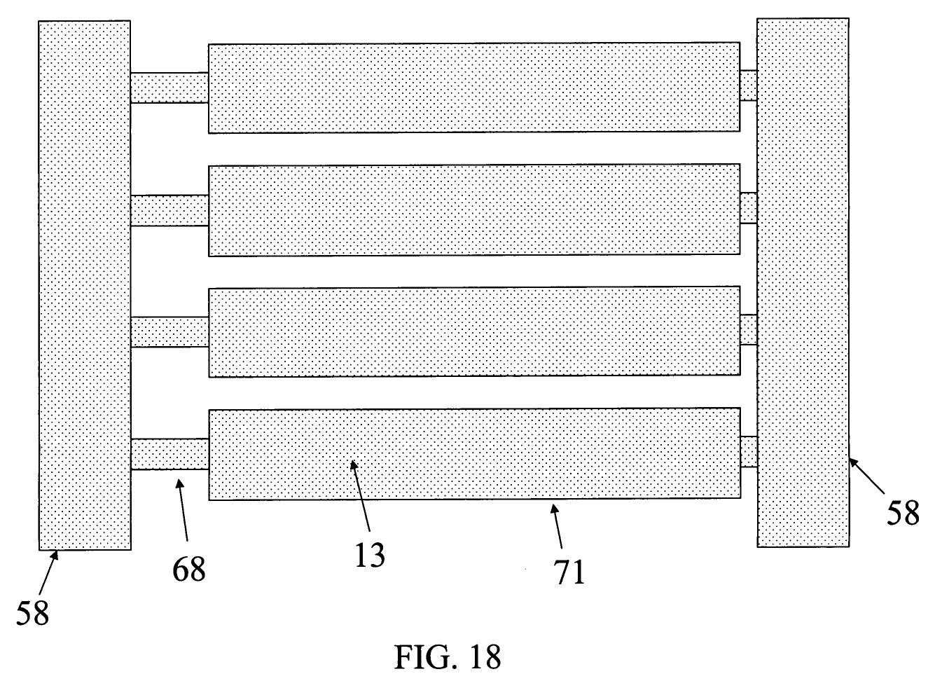

FIG. 18 represents the non-driven feed rollers 13 for the electrochemical transport and current conduction belt 11 turning system in their respective geometry.

While a particular embodiment of the present invention has been shown and described, it will be apparent to those skilled in the art that various changes and modifications may be made therein without departing from the spirit or scope of the invention. Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. Accordingly, it is intended to cover all alternatives, modifications, and equivalents as may be included within the spirit and scope of the invention defined in the appended claims

1. A fuelable electrochemical power system battery cell comprising:
an enclosed container means;
an electrolyte material disposed in said container means;
a non packaged electrochemical fuel supply means;
an exhausted electrochemical fuel storage means;
an exhausted electrochemical fuel removal means;
an electrical current removal means;
means for an internally configured and permanently affixed means for the formation, reaction, and reformation of a continuous electrochemical transport and current conduction belt for the conversion of electrochemical components into electrical energy in a continuous manner.

2. A continuous electrochemical transport and current conduction belt, wherein said belt comprises;
two belts of conductive material means;
means for a third belt of electrically nonconductive materials but porous for the purpose of allowing ion flow situated between the two conductive belts;
means for the insertion of electrochemical fuel in a plurality of forms on each side of the electrically nonconductive third and middle belt such that it is located between the third belt and a conduction belt;
means for the separation of the three belts and the forcing of spent and unspent electrochemical fuel away from the three belts, said spent electrochemical fuel being collected by circulation, filtration, and gravity means into the spent electrochemical fuel storage area, and said belts being clear of residual material now being ready for replenishment with new electrochemical fuel;
means wherein electrochemical reactant plates of the present invention are formed by layering the solid active electrochemical fuel components into a totally internal and continuous loop carrier electrochemical transport and current conduction belt that maintains the required geometry of the reactants and carries them into the electrolyte.

3. The fuel-able electrochemical power system battery cell of claim 1 wherein means to control the current and potential produced are provided by varying the speed and electrochemical replenishment rate of the continuous electrochemical transport and current conduction belt.

4. The fuel-able electrochemical power system battery cell of claim 1 wherein an electrochemically active compartment containing an aqueous, gaseous, or solid source of an electrolyte, a cathode and an anode formed by a continuous belt comprising an endless loop made of at least three sections, and electrical current pickup and supply to the external load is provided by means of the belt guide rollers.

5. The fuel-able electrochemical power system battery cell of claim 1 wherein a belt forming apparatus is provided for the forming of the electrochemistry, wherein the electrochemistry is automatically configured into the proper geometry for optimum battery performance without the need of external electrochemical transport and current conduction belts or external electrochemical packaging.

6. The fuel-able electrochemical power system battery cell of claim 1 wherein bulk electrochemical materials are added and their electrochemical reactants are removed with the resultant production of electrical potential and current.

7. The fuel-able electrochemical power system battery cell of claim 1 wherein electrochemical fuel may be fed into the battery cell in a number of forms including but not limited to liquids, pellets, paste, flakes, powder, granules, slugs, ribbon, chunks or any other form as may be contained or semi contained between two opposing planes as provided by the continuous electrochemical transport and current conduction belt providing the widest means for the use of any electrochemistry.

8. The fuel-able electrochemical power system battery cell of claim 1 wherein electrolyte can be added or removed or its concentration altered while the cell is in operation.

9. The fuel-able electrochemical power system battery cell of claim 1 wherein means are provided for the electrochemical transport and current conduction belt velocity is determined by monitoring the battery voltage and current, and adjusting the electrochemical transport and current conduction belt velocity accordingly, thereby augmenting the amount of electrochemical reactant solid material remaining in the electrolyte and adding new material in predetermined increments as necessary.

10. The continuous electrochemical transport and current conduction belt of claim 2 wherein the conduction belt components of the electrochemical transport and current conduction belt act as the conductor to remove electrical current as it is produced.

11. The continuous electrochemical transport and current conduction belt of claim 2 wherein the spent electrochemical reactant material is removed from the electrochemical transport and current conduction belt by mechanically separating the electrochemical transport and current conduction belt layers and driving the electrolyte solution through the electrochemical transport and current conduction belt components, first from one side and then the other, to “blow” or force out any remaining reactant or spent reactant material.

12. The continuous electrochemical transport and current conduction belt of claim 2 wherein means are provided for the electrolyte to be continuously pumped through the belt to aid in the removal of spent electrochemical product buildup on the solid reactants of the cell.

13. The continuous electrochemical transport and current conduction belt of claim 2 wherein means are provided for the formation of a continuous electrochemical transport and current conduction belt battery cell, being subdivided into a plurality of electrochemical cells comprising a high current source at a desirable voltage.

14. The continuous electrochemical transport and current conduction belt of claim 2 wherein are provided means for wiping action due to continuous belt slippages continuously exposing new electrochemical fuel surface and allowing spent electrochemical material to fall out.

15. The continuous electrochemical transport and current conduction belt of claim 2 wherein the center electrically non-conductive belt is wider than the electrically conducting belts.

16. The continuous electrochemical transport and current conduction belt of claim 2 wherein the center electrically non-conductive belt extends to both sides of the two electrically conductive belts.

17. The continuous electrochemical transport and current conduction belt of claim 2 wherein the electrochemical transport and current conduction belt is reloaded with the electrochemical components and mechanically layered into the proper geometry and the electrical production process is continuous and uninterrupted.

18. The continuous electrochemical transport and current conduction belt of claim 2 wherein the energy density and capacity of the fuel-able electrochemical power system battery cell is determined by the width of the electrochemical transport and current conduction belt and the corresponding width of the electrochemical load that can be realized, and the number of electrochemical transport and current conduction belt turns around the electrical pickoff rollers, and the length of the electrochemical transport and current conduction belt between the electrical pickoff rollers.

19. The continuous electrochemical transport and current conduction belt of claim 2 wherein means further comprising contact terminals for contacting the conducting belts anode and cathode side on said continuous belt by contact with the rollers and belt guides are provided.

20. The continuous electrochemical transport and current conduction belt of claim 2 wherein said belt is continuous and said electrochemical fuel load is segmented into sections.

21. The continuous electrochemical transport and current conduction belt of claim 2 wherein said belt is continuous and said electrochemical fuel load is continuous.

22. The continuous electrochemical transport and current conduction belt of claim 2 wherein said electrical nonconductive divider belt has porous sections separated by nonporous sections.

23. The continuous electrochemical transport and current conduction belt of claim 2 wherein said electrical nonconductive divider belt is porous.

24. The continuous electrochemical transport and current conduction belt of claim 2 wherein said electrical nonconductive divider belt is non-porous.
